(19) United States
(12) Patent Application Publication
(10) Pub. No.: US 2005/0276573 A1
(43) Pub. Date: Dec. 15, 2005

(54) Method and apparatus to edit a media file

(76) Inventor: Jeffrey A. Abbate, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,285

(22) Filed: May 28, 2004

(51) Int. Cl. H04N 5/76

(52) U.S. Cl. 386/52; 386/55

(57) ABSTRACT

Method and apparatus to edit a media file are described.

### BACKGROUND

Commercial quality media editing systems are becoming increasingly available to private consumers. A media recording system can be used to record and archive personal or commercial content, such as a movie, television program, or home video. A media editing system can be used to edit the content, such as adding titles, voice, music, graphics, scene transitions, and so forth. Consequently, consumers may desire enhanced editing operations to facilitate authoring personalized content. Accordingly, there may be a need for improvements in such techniques in a device or network.

### BRIEF DESCRIPTION OF THE DRAWINGS

FIG. 1 illustrates a block diagram of a system 100;

FIG. 2 illustrates a block diagram of a system 200;

FIG. 3 illustrates a block diagram of a system 300; and

FIG. 4 illustrates a processing logic 400.

### DESCRIPTION OF SPECIFIC EMBODIMENTS

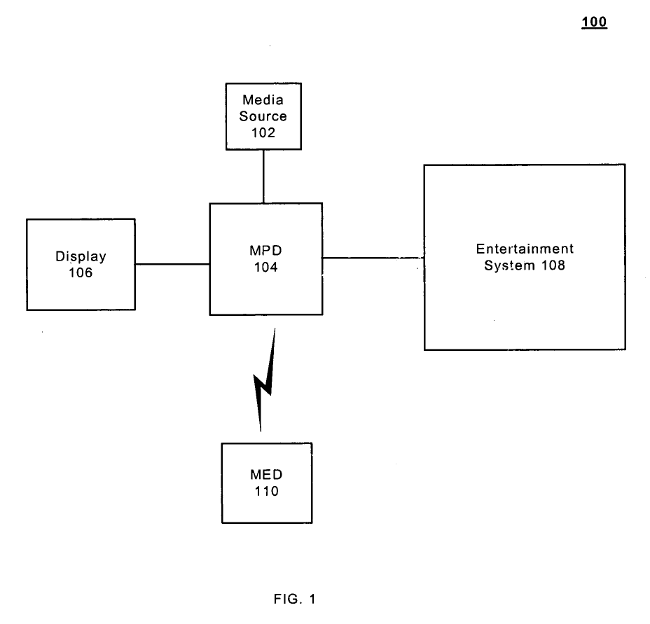

FIG. 1 illustrates a block diagram of a system 100. System 100 may comprise a communication system to communicate information between multiple nodes. A node may comprise any physical or logical entity having a unique address in system 100. The unique address may comprise, for example, a network address such as an Internet Protocol (IP) address, device address such as a Media Access Control (MAC) address, and so forth.

In one embodiment, communications media may connect the nodes. Communications media may comprise any media capable of carrying information signals. Examples of communications media may include metal leads, semiconductor material, twisted-pair wire, co-axial cable, fiber optic, radio frequencies (RF) and so forth. The terms “connection” or “interconnection,” and variations thereof, in this context may refer to physical connections and/or logical connections.

In one embodiment, the nodes may communicate information using the communications media. Examples of such information may include media information and control information. Media information may refer to any data representing content meant for a user, such as voice information, video information, audio information, text information, alphanumeric symbols, graphics, images, and so forth. In one embodiment, for example, media information may include personal or commercial media content, such as commercial movies, personal movies, television programs, music, and so forth. Control information may refer to any data representing commands, instructions or control words meant for an automated system. For example, control information may be used to route media information through a system, or instruct a node to process the media information in a predetermined manner.

Referring again to FIG. 1, system 100 may comprise multiple nodes to include a media source 102, a media processing device (MPD) 104, a display 106, an entertainment system 108, and a media editing device (MED) 110. Although FIG. 1 shows a limited number of nodes, it can be appreciated that any number of nodes may be used in system 100. The embodiments are not limited in this context.

In one embodiment, system 100 may comprise media source 102. Media source 102 may comprise any source arranged to deliver media information. For example, media source 102 may comprise a multimedia distribution system to provide analog or digital audio signals, video signals, or audio/visual (A/V) signals to media processing device 102. Examples of multimedia distribution systems may include Over The Air (OTA) broadcast systems, terrestrial cable systems (CATV), satellite broadcast systems, video surveillance systems, teleconferencing systems, telephone systems, and so forth. The embodiments are not limited in this context.

In one embodiment, system 100 may comprise entertainment system 108. Entertainment system 108 may comprise any system arranged to reproduce media information from media source 102 and/or MPD 104. An example of entertainment system 108 may include any television system having a display and speakers. Another example of entertainment system 108 may include an audio system, such as a receiver or tuner connected to external speakers. Yet another example of entertainment system 108 may include a computer having a display and speakers. The embodiments are not limited in this context.

In one embodiment, system 100 may comprise display 106. Display 106 may comprise a display for a video system or computer system. Display 106 may display media information received from media source 102 and/or MPD 104.

In one embodiment, system 100 may comprise MPD 104. MPD 104 may be connected to media source 102, display 106, and entertainment system 108. MPD 104 may comprise a device having a processing system arranged to process media information for one or more nodes of system 100. In addition, MPD 104 may be arranged to perform editing operations for media information for one or more nodes of system 100. In one embodiment, for example, MPD 104 may be implemented as a separate dedicated device to perform media processing and editing operations as defined herein. In another embodiment, for example, MPD 104 may be integrated with other conventional media devices, such as a media computer, media center, set top box (STB), Personal Video Recorder (PVR), Digital Video Disc (DVD) device, a Video Cassette Recorder (VCR), a digital VCR, a computer, an electronic gaming console, a Compact Disc (CD) player, a digital camera, an A/V camcorder, and so forth. In the latter case, the integrated device may be enhanced to perform the editing operations as defined herein.

In one embodiment, MPD 104 may access media information from a number of different sources. For example, MPD 104 may receive media information from media source 102 in the form of television signals. In another example, MPD 104 may retrieve media information stored on machine-readable media. Examples of machine-readable media may include read-only memory (ROM), random-access memory (RAM), dynamic RAM (DRAM), double DRAM (DDRAM), static RAM (SRAM), programmable ROM, erasable programmable ROM, electronically erasable programmable ROM, dynamic RAM, magnetic disk such as a floppy disk or hard drive, optical disk such as CD-ROM or DVD, magnetic tape such as Digital Video (DV) tapes, and any other media suitable for storing analog or digital information.

In one embodiment, MPD 104 may be a device arranged to perform conventional media processing operations, such as storing and reproducing media information. In this context, MPD 104 may perform such operations using hardware and/or software similar to conventional media devices as previously described. The embodiments are not limited in this context.

In one embodiment, MPD 104 may also be arranged to perform enhanced media processing operations, such as authoring or editing operations for media information. Examples of editing operations may include adding titles, background music, graphic overlays, defining scene sequences and transitions, and so forth. In the past, authoring or editing operations were typically performed using commercial editing systems. Such functionality, however, is becoming increasingly available to consumers, thereby allowing consumers to author personalized content. Accordingly, MPD 104 may include an editing application program to combine conventional media processing operations with enhanced editing operations to facilitate such authoring.

It is worthy to note that although media processing device 102 and entertainment system 108 are shown in FIG. 1 as separate systems, it may be appreciated that these two systems may be implemented in a single integrated system. An example of such an integrated system may comprise a digital television having a processor and memory.

In one embodiment, system 100 may include MED 110. MED 110 may comprise a wireless node arranged to communicate with MPD 104. Examples of MED 110 may include a wireless computer, laptop, ultra-portable computer, handheld devices such as personal digital assistant (PDA) or computer, and so forth. MED 110 may also include an editing application program similar to MPD 104. In one embodiment, the editing application program of MED 110 provides a subset of media processing operations of the editing application program of MPD 104. Alternatively, MPD 104 and MED 110 may use the same editing application program providing the same media processing functionality. The embodiments are not limited in this context.

In one embodiment, MPD 104 may be in wireless communication with MED 110 over a wireless medium, such as RF spectrum. MPD 104 and MED 110 may communicate media information and control information in accordance with one or more protocols. A protocol may comprise a set of predefined rules or instructions to control how the nodes communicate information between each other. The protocol may be defined by one or more protocol standards, such as the standards promulgated by the Internet Engineering Task Force (IETF), International Telecommunications Union (ITU), Institute of Electrical and Electronic Engineers (IEEE), a company such as Intel® Corporation, and so forth. In one embodiment, for example, MPD 104 and MED 110 may communicate using various wireless protocols, such as the IEEE 802.11 family of protocols, Bluetooth, Ultra Wide Band (UWB), and so forth. Alternatively, MPD 104 and MED 110 may communicate using wired communication media and accompanying protocols, such as IEEE 10/100 Ethernet, Universal Serial Bus (USB), 1394 FireWire, and so forth. The embodiments are not limited in this context.

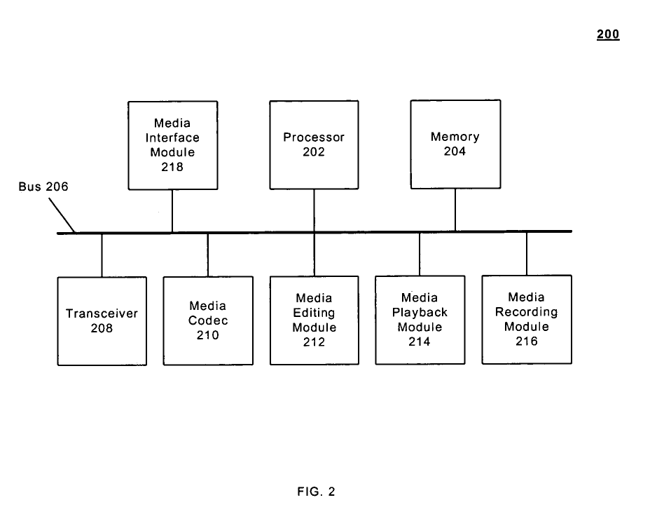

In one embodiment, MED 110 may operate in combination with MPD 104 to add further convenience to the consumer in editing media information. MED 110 may comprise a device to perform editing operations similar to the editing application program implemented with MPD 104. In addition, MED 110 and MPD 104 may be arranged so that MED 110 may remotely access media information stored by MPD 104, as well as access advanced editing operations provided by the editing application program of MPD 104. Further, MPD 104 may comprise a wireless device to allow a user more flexibility in when and where such editing operations are performed. MPD 104 and MED 110 may be discussed in more detail with reference to FIGS. 2-4.

FIG. 2 illustrates a block diagram of a system 200. System 200 may be representative of, for example, MPD 104 described with reference to FIG. 1. As shown in FIG. 2, MPD 200 may comprise a plurality of elements, such as a processor 202, a memory 204, a transmitter/receiver (“transceiver”) 208, a media coder/decoder (“codec”) 210, a media editing module 212, a media playback module 214, and a media recording module 216, all connected via a communication bus 206. Communication bus 206 may comprise any standard communication bus, such as a Peripheral Component Interconnect (PCI) bus, for example. The term “module” as used herein may refer to one or more circuits, components, registers, processors, software subroutines, or any combination thereof. Although FIG. 2 shows a limited number of elements, it can be appreciated that any number of elements may be used in MPD 200.

In one embodiment, MPD 200 may comprise processor 202. Processor 202 can be any type of processor capable of providing the speed and functionality desired for an embodiment. For example, processor 202 could be a processor made by Intel® Corporation and others. Processor 202 may also comprise a digital signal processor (DSP) and accompanying architecture. Processor 202 may further comprise a dedicated processor such as a network processor, embedded processor, micro-controller, controller and so forth. The embodiments are not limited in this context.

In one embodiment, MPD 200 may comprise memory 204. Memory 204 may comprise any type of machine-readable media as discussed previously. In one embodiment, for example, memory 204 may comprise a form of temporary memory such as RAM, or permanent storage such as a magnetic disk hard drive. The embodiments are not limited in this context.

In one embodiment, MPD 200 may comprise transceiver 208. Transceiver 208 may be used to communicate media information and control information between MPD 200 and MED 110. Transceiver 208 may comprise a transmitter and a receiver, either implemented alone or in combination.

In one embodiment, the transmitter may comprise any transmitter system configured to transmit an electromagnetic signal, such as a RF signal at a desired operating frequency. The transmitter may comprise a transmitter antenna operatively coupled to an output stage. The output stage may comprise various conventional driving and amplifying circuits, including a circuit to generate an electric current. When the electric current is supplied to the transmitter antenna, the transmitter antenna may generate electromagnetic signals around the transmitter antenna at or around the operating frequency. The electromagnetic signals may propagate between MPD 104 and MED 110.

In one embodiment, the receiver may comprise any receiver system configured to receive RF signals from the transmitter at a predetermined operating frequency. For example, the receiver may comprise conventional amplifying and signal-processing circuits, such as band pass filters, mixers, and amplifier circuits. In addition, the receiver may comprise an output stage connected system 200 via bus 206.

In one embodiment, transceiver 208 may operate using any desired frequency band allocated for consumer electronics, such as frequency band within the 890-960 Megahertz (MHz) range, 1990-2110 MHz range, 2400-2500 MHz range, 5 Gigahertz (GHz), or other frequency ranges as approved by FCC regulations. The selected frequency band should provide sufficient bandwidth to provide real time communications in accordance with a desired set of quality and latency parameters for a given implementation. The embodiments are not limited in this context.

In one embodiment, MPD 200 may comprise media playback module 214 and media recording module 216. Media playback module 214 may be used to reproduce media information. Media recording module 216 may be used to store or archive media information. The media information may be stored on different machine-readable media in a number of different formats. For example, the media information may be digital media information recorded on a Digital Video (DV) tape, Digital8 tape, MicroMV digital camcorder tape, and so forth. In another example, the media information may be analog media information recorded on an 8 millimeter (mm) tape, Video Home System (VHS) tape, Super VHS (SVHS) tape, VHS-Camcorder (VHS-C), SVHS-C, and so forth. In yet another example, the media information may be media information stored in one or more digital computer formats, such as Audio Video Interleave (AVI), Resource Interchange File Format (RIFF), Moving Pictures Expert Group (MPEG-1), MPEG-2, Real Video, Windows Media Format (WMF), and so forth. The types of machine-readable media and recording formats are not limited in this context.

In one embodiment, MPD 200 may comprise media codec 210. Media codec 210 may be used to compress media information from a first format having a first resolution to a second format having a second resolution. The first format may comprise the format originally used to store the media file on the machine-readable media, as previously described. The first format may also be referred to as the source format. Media coded 210 may compress the media file from the source format to a second format. In one embodiment, the second format may have a smaller file size and lower resolution than the first format. The smaller file size may allow the media file to be communicated using a lower bandwidth connection, and may also consume less memory space, which may be important when communicating the encoded media file to MED 110.

The operation of media codec 210 may be illustrated using an example. Assume a media file is stored using a source format of in accordance with MPEG-2. The MPEG-2 video syntax can be applied at a wide range of bit rates and sample rates. For example, a typical MPEG-2 format has a first level format that comprises a Source Input Format (SIF) of 352 pixels/line×240 lines×30 frames/sec, also known as Low Level (LL). MPEG-2 also has a second level format referred to as “CCIR 601,” that comprises 720 pixels/line×480 lines×30 frames/sec, also known as Main Level (ML). Assume that the media file is stored using MPEG-2 ML, which provides a standard DVD level resolution with an uncompressed file size of approximately 77 Gigabytes (GB) for approximately 60 minutes of footage. Media codec 210 may encode the media file to a smaller file size having a much lower level of resolution. The smaller file size consumes less bandwidth and less memory at the cost of resolution, quality, frame rate, or any combination of such characteristics or others as may be possible with a chosen media codec. The encoded media file, however, should preserve or largely preserve the timing of the video and audio segments as with the source format. The encoded media file should also provide a sufficient combination of resolution, quality, frame rate, and timing information for a user to perform editing operations using MED 110. The embodiments are not limited in this context.

Media codec 210 may perform encoding operations for a media file in a number of different contexts. For example, media codec 210 may encode a media file in response to an external request, such as a request by MED 110. In another example, media codec 210 may automatically encode media files when received, during certain time periods such as 12:00-8:00 AM, during certain days, on a periodic basis, and so forth. The embodiments are not limited in this context.

In one embodiment, MPD 200 may comprise media editing module 212. Media editing module 212 may comprise any editing application program arranged to provide a user with editing operations as previously described. In one embodiment, for example, media editing module 212 may comprise an editing application program such as Studio Version 9 made by Pinnacle Systems, Windows Movie Maker made by Microsoft Corporation, or other available editing application programs. In addition, a server may be used to upgrade the editing operation capabilities of media editing module 212 via transceiver 208 or a wired connection. The embodiments are not limited in this context.

In one embodiment, media editing module 212 may use resident media editing operations to edit a media file. In this context, resident may refer to those media editing capabilities that are stored by MPD 200. In the event media editing module 212 does not have one or more editing capabilities needed to edit a media file, however, media editing module 212 may request additional editing capabilities from other devices connected to MPD 200 via a wired or wireless connection. For example, MPD 200 may download the desired editing capabilities from a number of different nodes or devices, such as web server via an Internet connection, a PC or handheld connected to MPD 200, and so forth. The embodiments are not limited in this context.

In one embodiment, MPD 200 may comprise media interface module 218. Media interface module 218 may comprise an interface to communicate control information between MED 110 and MPD 200. For example, media interface module 218 may communicate control information received from MED 110 to media playback module 214, with the control information to instruct media playback module 214 to begin reproducing a media file stored in memory 204 using display 106 or entertainment system 108. In another example, media editing module 212 may communicate control information received from MED 110 to media editing module 212, to remotely edit the media file reproduced by display 106 or entertainment system 108. Media interface module 218 may be implemented using a predefined set of application program interfaces (API), for example.

In general operation, media source 102 may provide media information to MPD 200. MPD 200 may display the media information as it is received from media source 102 using display 106 or entertainment system 108. MPD 200 may also store the media information in a media file using a machine-readable medium for later reproduction. For example, the media information may be stored in a hard drive or writable DVD. A user may use MED 110 to access a media file stored by MPD 200 or accessible by MPD 200. The user may also use MED 110 to perform editing operations for the media file remotely from MPD 200. MED 110 may be used to perform the editing operations in various modes, such as a remote viewing mode or local viewing mode.

In one embodiment, for example, MED 110 may perform editing operations in a local viewing mode. In local viewing mode, MED 110 may request MPD 200 to send a media file to MED 110. MPD 200 may receive the request via transceiver 208, and retrieve the requested media file from memory 204 or a machine-readable media (e.g., DVD) inserted into media playback module 214. MPD 200 may send the retrieved media file to MED 110 using transceiver 208. MPD 200 may send the retrieved media file in the original format and file size if the connection between MPD 200 and MED 110 has sufficient bandwidth and MED 110 has sufficient memory to store the uncompressed media file. Alternatively, MPD 200 may also encode the media file using media codec 210 in order to reduce the file size. The reduced file size, however, may also result in a corresponding reduction in video resolution, quality, frame rate, or some other characteristic for the decoded media file relative to the original media file. A user may find the encoded media file acceptable, however, to perform the editing operations as long as the timing of the original media file is preserved. A user may then use MED 110 to reproduce the downloaded media file to view while performing “offline” editing operations for the media file.

In one embodiment, for example, MED 110 may perform editing operations in a remote viewing mode. In remote viewing mode, MED 110 may send control information to access media playback module 214 via media interface module 218. The control information may instruct media playback module to reproduce a media file using display 106 or entertainment system 108. This may provide the advantage of allowing the user access to the higher resolution of the original media file. A user may then perform editing operations using MED 110 while viewing the media file on a device other than MED 110. In remote viewing mode, the connection between MED 110 and MPD 200 should have sufficient bandwidth and latency constraints to allow real time communication of the control information.

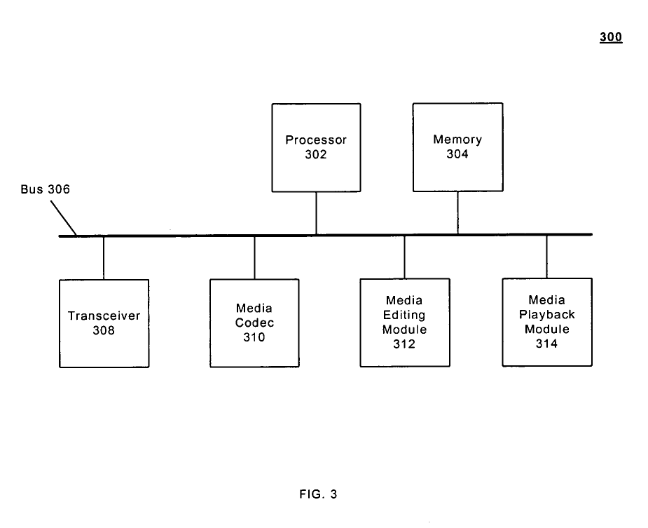

FIG. 3 illustrates a block diagram of a system 300. System 300 may be representative of, for example, MED 110 described with reference to FIG. 1. As shown in FIG. 2, MED 300 may comprise a plurality of elements, such as a processor 302, a memory 304, a transceiver 308, a media codec 310, a media editing module 312, a media playback module 314, all connected via a communication bus 306. Although FIG. 3 shows a limited number of elements, it can be appreciated that any number of elements may be used in MED 300.

In one embodiment, some elements of MED 300 may be similar to those of MPD 200. For example, processor 302, memory 304, communication bus 306, transceiver 308, media code 310, and media playback module 314 of MED 300 maybe similar to corresponding elements 202, 204, 206, 208, 210 and 214 of MPD 200. The embodiments are not limited in this context.

In one embodiment, MED 300 may comprise media editing module 312. Media editing module 312 may comprise an editing application program similar to media editing module 212 of MPD 200. Media editing module 312 may perform editing operations for a media file as received from MPD 200 or reproduced by display 106 or entertainment system 108. Media editing module 312 may respond to user commands to perform edit operations on the media file. For example, a user may catalog the desired scenes, create a timeline sequence for a movie, add titles, add transitions, add music tracks, and so forth. Media editing module 312 may summarize the edit operations in the form of an Edit Decision List (EDL). The EDL is a list of all the edit operations used to make an edited media file, including the position of certain elements within the edited media file. An example of an EDL may be illustrated in Table 1 as follows.

TABLE 1

| Start | Length | Edit Operation |
|---|---|---|
| 0:00.00 | :05:00 | Display Logo |
| 0:05:00 | 5:28.15 | Insert Teaser |
| 5:33.15 | 2:30.23 | Insert Background Music |
| 8:04.10 | 9:46.07 | Act 1 |
| 17:50.15 | 1:31.23 | Insert Advertisement |
| 19:22.10 | :05.00 | Insert Title |
| 19.27.10 | 2:30.03 | Insert Advertisement |
| 21:57.11 | 9:16.19 | Act 2 |
| 31:14.00 | 2:32.00 | Insert Voice-Over |
| 33:46.00 | :37.20 | End Credits |
| 34:22.20 | | End |

As shown in Table 1, the EDL comprises a Start Time, a Length, and an Edit Operation. The Start Time and Length are represented using time codes as defined by, for example, the Society of Motion Picture and Television Engineers (SMPTE). The SMPTE time codes describe the position of the elements within the final edited media file.

In general operation, a user may use MED 300 to access a media file either in local viewing mode or remote viewing mode. In either case, the user may use MED 300 to create an EDL for the reproduced media file using media editing module 312. The EDL may be sent to MPD 200 via transceiver 308. Once MPD 200 receives an EDL from MED 300, media editing module 212 of MPD 200 may edit the media file in accordance with the received EDL. The edited media file may be stored in memory 304, stored using a machine-readable media via media recording module 216, or reproduced by media playback module 214 using display 106 or entertainment system 108.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

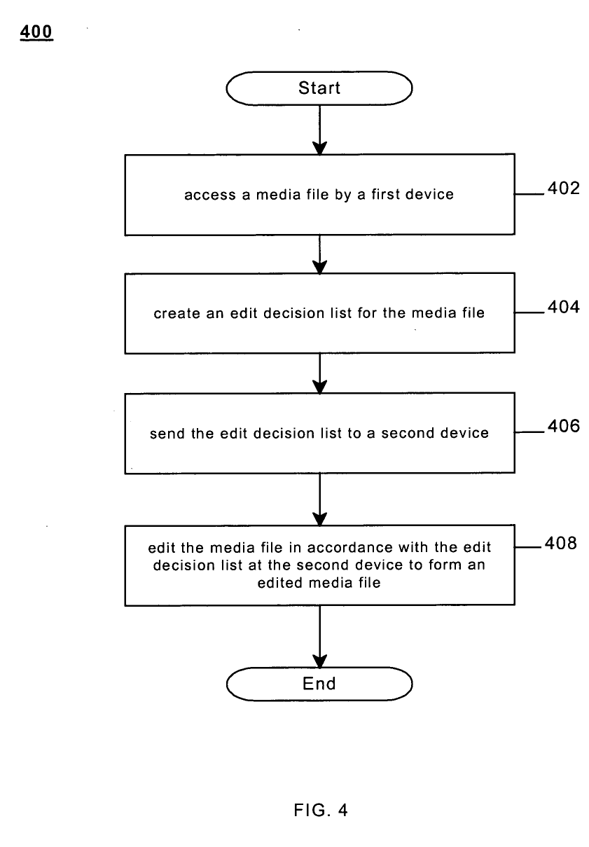

FIG. 4 illustrates a programming logic 400. FIG. 4 illustrates a programming logic 400 that may be representative of the operations executed by one or more systems described herein, such as systems 100-300. As shown in programming logic 400, a media file may be accessed by a first device at block 402. An EDL may be created for the media file at block 404. The EDL may be sent to a second device at block 406. The media file may be edited in accordance with the EDL at the second device to form an edited media file at block 406.

In one embodiment, the media file may be accessed by the first device at block 402 by sending a request for the media file to the second device. The second device may receive the request for the media file. The second device may encode the media file, and send the encoded media file to the first device in response to the request. The first device may receive the encoded media file from the second device. The first device may decode the encoded media file, and reproduce the decoded media file at the first device. The decoded media file may comprise a fewer number of bits than the media file encoded by the second device.

In one embodiment, the media file may be accessed by the first device at block 402 by sending a request to access the media file by the second device. The first device may send control information to the second device to reproduce the media file at the second device. The second device may reproduce the media file in response to the control information.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

All or portions of an embodiment may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

1. A system, comprising:
a media source;
a media processing device to connect to said media source, said media processing device having a first transceiver to receive a media file from said media source, a media recording module to record said media file, and a first media editing module to edit said media file using an edit decision list; and
a media editing device to connect to said media processing device, said media editing device having a second media editing module to create said edit decision list for said media file, and a second transceiver to transmit said edit decision list to said media processing device.

2. The system of claim 1, wherein said first transceiver is arranged to receive said edit decision list, and said first media editing module is arranged to edit said media file using said edit decision list to form an edited media file.

3. The system of claim 1, wherein said media processing device includes a media encoding module, said media encoding module to encode said media file to create an encoded media file having a fewer number of bits than said media file, and said second transceiver to transmit said encoded media file to said media editing device.

4. The system of claim 1, wherein said media editing device includes a media decoding module, said second transceiver to receive an encoded media file, and said media decoding module to decode said encoded media file.

5. An apparatus, comprising:
a media processing device having a first transceiver to receive a media file, a media recording module to record said media file, and a first media editing module to edit said media file using an edit decision list; and
a media editing device to connect to said media processing device, said media editing device having a second media editing module to create said edit decision list for said media file, and a second transceiver to transmit said edit decision list to said media processing device.

6. The apparatus of claim 5, wherein said first transceiver is arranged to receive said edit decision list, and said first media editing module is arranged to edit said media file using said edit decision list to form an edited media file.

7. The apparatus of claim 5, wherein said media processing device includes a media encoding module, said media encoding module to encode said media file to create an encoded media file having a fewer number of bits than said media file, and said second transceiver to transmit said encoded media file to said media editing device.

8. The apparatus of claim 5, wherein said media editing device includes a media decoding module, said second transceiver to receive an encoded media file, and said media decoding module to decode said encoded media file.

9. The apparatus of claim 5, wherein said media processing device includes a media playback module and a display, said media playback module to reproduce said media file using said display.

10. The apparatus of claim 9, wherein said media processing device includes a media interface module, said media interface module to receive control information from said second media editing module to control said media playback module to reproduce said media file using said display.

11. A method, comprising:
accessing a media file by a first device;
creating an edit decision list for said media file;
sending said edit decision list to a second device; and
editing said media file in accordance with said edit decision list at said second device to form an edited media file.

12. The method of claim 11, wherein said accessing comprises sending a request for said media file to said second device.

13. The method of claim 12, wherein said accessing further comprises:
receiving said request for said media file at said second device;
encoding said media file by said second device; and
sending said encoded media file to said first device.

14. The method of claim 13, wherein said accessing further comprises:
receiving said encoded media file from said second device;
decoding said encoded media file; and
reproducing said decoded media file at said first device.

15. The method of claim 14, wherein said decoded media file comprises a fewer number of bits than said media file encoded by said second device.

16. The method of claim 11, wherein said accessing comprises:
sending a request to access said media file by said second device;
sending control information to said second device to reproduce said media file at said second device; and
reproducing said media file at said second device in response to said control information.

17. The method of claim 11, wherein said edit decision list includes a list of editing operations, further comprising:
determining whether said second device can perform said editing operations; and
retrieving editing application software to perform said editing operations in accordance with said determination.

18. An article comprising:
a storage medium;
said storage medium including stored instructions that, when executed by a processor, are operable to access a media file by a first device, create an edit decision list for said media file, send said edit decision list to a second device, and edit said media file in accordance with said edit decision list at said second device to form an edited media file.

19. The article of claim 18, wherein the stored instructions, when executed by a processor, perform said access using stored instructions operable to send a request for said media file to said second device.

20. The article of claim 19, wherein the stored instructions, when executed by a processor, perform said access using stored instructions operable to receive said request for said media file at said second device, encode said media file by said second device, and send said encoded media file to said first device.

21. The article of claim 20, wherein the stored instructions, when executed by a processor, perform said access using stored instructions operable to receive said encoded media file from said second device, decode said encoded media file, and reproduce said decoded media file at said first device.

22. The article of claim 18, wherein the stored instructions, when executed by a processor, perform said access using stored instructions operable to send a request to access said media file by said second device, send control information to said second device to reproduce said media file at said second device, and reproduce said media file at said second device in response to said control information.
